(19) United States
(12) Patent Application Publication
(10) Pub. No.: US 2019/0084507 A1
(43) Pub. Date: Mar. 21, 2019

(54) IMAGING APPARATUS

(71) Applicant: TOYOTA JIDOSHA KABUSHIKI KAISHA, Toyota-shi (JP)

(72) Inventor: Masakazu NISHIJIMA, Ebina-shi (JP)

(73) Assignee: TOYOTA JIDOSHA KABUSHIKI KAISHA, Toyota-shi (JP)

(21) Appl. No.: 16/135,279

(22) Filed: Sep. 19, 2018

(30) Foreign Application Priority Data
Sep. 21, 2017 (JP) 2017-181521

(51) Int. Cl. B60R 16/03; G06K 9/00; B60R 1/00

(52) U.S. Cl. CPC B60R 16/03; B60R 1/005; G06K 9/00825

(57) ABSTRACT

An imaging apparatus is configured to photograph an image of a scene ahead of a vehicle, and is provided with: an actuator configured to adjust a relative position of an imaging sensor with respect to a lens; and a controller configured to control the actuator in such a manner that light that enters from above the lens enters the imaging sensor when a speed of the vehicle is less than a predetermined speed, in comparison with when the speed of the vehicle is greater than the predetermined speed.

### CROSS-REFERENCE TO RELATED APPLICATIONS

This application is based upon and claims the benefit of priority of the prior Japanese Patent Application No. 2017-181521, filed on Sep. 21, 2017, the entire contents of which are incorporated herein by reference.

### BACKGROUND

### 1. Technical Field

Embodiments of the present disclosure relate to an imaging apparatus configured to image or photograph an image of a scene ahead of a vehicle.

### 2. Description of the Related Art

In this type of imaging apparatus, an imaging direction is fixed. Thus, when a vehicle stops at a red light, a traffic light, which is located at a higher position as viewed from the vehicle, is sometimes out of an imaging range. As a measure of avoiding such a situation, for example, there is disclosed a technology/technique in which the vehicle is set to be stopped at a recognition limit distance at which the traffic light can be recognized by an imaging apparatus when the vehicle stops at the red light (refer to Japanese Patent Application Laid Open No. 2010-146284 (Patent Literature 1)).

The recognition limit distance described in the Patent Literature 1 described above, however, may be set significantly before (e.g., several meters before) a stop line. In this case, the vehicle may stop at a position at which the vehicle is originally not to stop, and this is not desirable from the viewpoint of following traffic rules.

On the other hand, there is also a possible measure of changing the direction of the imaging apparatus (e.g., directing the imaging apparatus upward to allow the traffic light located above to come in sight) when the vehicle stops; however, there may be a significant impact in changing the direction, which may also deteriorate durability of the apparatus. A high electric power is also required to drive the apparatus, which is technically problematic.

### SUMMARY

In view of the aforementioned problems, it is therefore an object of embodiments of the present disclosure to provide an imaging apparatus configured to image or photograph a traffic light even when a vehicle stops.

The above object of embodiments of the present disclosure can be achieved by an imaging apparatus configured to photograph an image of a scene ahead of a vehicle, the imaging apparatus provided with: an actuator configured to adjust a relative position of an imaging sensor with respect to a lens; and a controller configured to control the actuator in such a manner that light that enters from above the lens enters the imaging sensor when a speed of the vehicle is less than a predetermined speed, in comparison with when the speed of the vehicle is greater than the predetermined speed.

### BRIEF DESCRIPTION OF THE DRAWINGS

FIG. 1 is a block diagram illustrating a configuration of an imaging apparatus according to a first embodiment;

FIG. 2A is a perspective view illustrating a state before moving an imaging sensor in the imaging apparatus according to the first embodiment;

FIG. 2B is a perspective view illustrating a state after moving the imaging sensor in the imaging apparatus according to the first embodiment;

FIG. 3A is a conceptual diagram illustrating an example of a traffic light within a field angle or a viewing angle;

FIG. 3B is a conceptual diagram illustrating an example of deviation of the traffic light from the field angle, which occurs in stopping at a red light;

FIG. 4 is a flowchart illustrating a flow of operation of the imaging apparatus according to the first embodiment;

FIG. 5 is a plan view illustrating an imaging range when the imaging sensor is at a normal position;

FIG. 6 is a plan view illustrating an imaging range when the imaging sensor is at a lower position;

FIG. 7A is a perspective view illustrating a state before moving the imaging sensor in the imaging apparatus according to a second embodiment;

FIG. 7B is a perspective view illustrating a state after moving the imaging sensor in the imaging apparatus according to the second embodiment; and

FIG. 8 is a side view illustrating a direction of driving the imaging sensor in the imaging apparatus according to the second embodiment.

### DETAILED DESCRIPTION OF THE EMBODIMENTS

Hereinafter, an imaging apparatus according to embodiments will be explained with reference to the drawings.

### First Embodiment

(1) Configuration of Apparatus

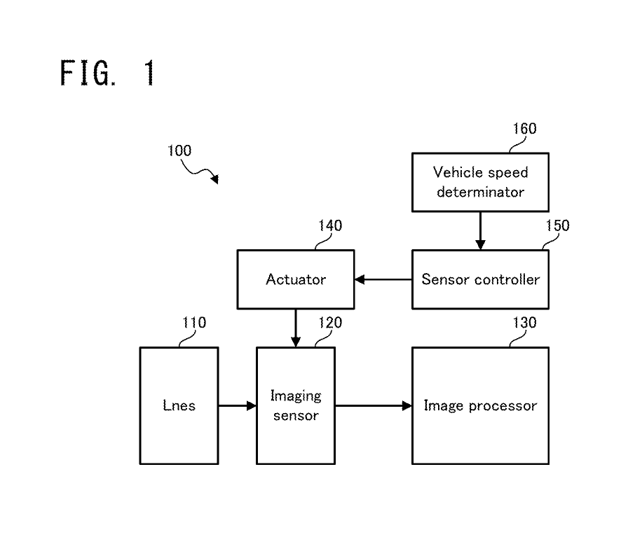

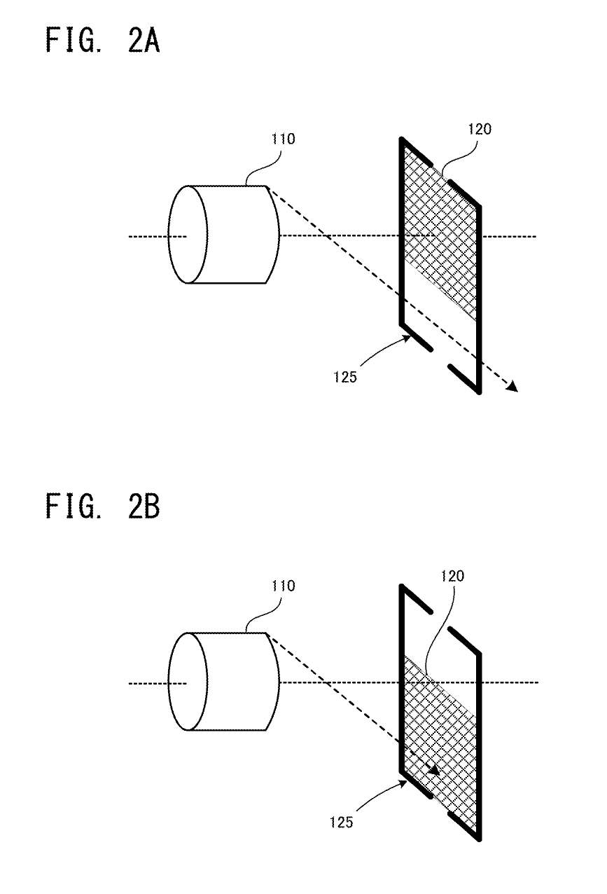

Firstly, a configuration of an imaging apparatus according to a first embodiment will be explained with reference to FIG. 1 to FIG. 2B. FIG. 1 is a block diagram illustrating the configuration of the imaging apparatus according to the first embodiment. FIG. 2A and FIG. 2B are perspective view respectively illustrating states before and after moving an imaging sensor in the imaging apparatus according to the first embodiment.

As illustrated in FIG. 1, an imaging apparatus 100 according to the first embodiment is provided with a lens 110, an imaging sensor 120, an image processor 130, an actuator 140, a sensor controller 150, and a vehicle speed determinator 160.

The imaging apparatus 100 is mounted, for example, near a windshield of a vehicle, and is configured to image or photograph an image of a scene ahead of the vehicle. In imaging, a signal according to light that enters from the lens 110 may be outputted from the imaging sensor 120, and the signal may be processed on the image processor 130, by which a photographed image is generated. The photographed image generated in this manner may be used, for example, for traffic light color recognition, obstacle detection, or the like.

On the imaging apparatus 100, a relative position of the imaging sensor 120 with respect to the lens 110 may be varied by the actuator 140. The operation of the actuator 140 may be controlled by the sensor controller 150, which is a specific example of the “controller” in Supplementary Notes described later. The sensor controller 150 is configured to control the operation of the actuator 140 on the basis of a determination result of the vehicle speed determinator 160. Thus, a position of the imaging sensor 120 may be changed in accordance with a vehicle speed. A flow of the operations here will be explained in detail later.

As illustrated in FIG. 2A and FIG. 2B, the imaging sensor 120 is configured to move between at a normal position (refer to FIG. 2A) and at a lower position (refer to FIG. 2B). Specifically, the imaging sensor 120 is configured to move in an upward/downward vertical direction, and is configured to change a relative height as viewed from the lens 110.

The normal position may be an arrangement in which an imaging range appropriate for the running of a vehicle 10 is realized, and may be, for example, an arrangement in which light that passes through a center of the lens 110 enters a center of the imaging sensor. On the other hand, in the case of the lower position, the imaging sensor is located on a lower side than the normal position. Thus, if the imaging sensor 120 is moved from the normal position to the lower position, the relative height of the imaging sensor 120 as viewed from the lens 110 is reduced. On the other hand, if the imaging sensor 120 is moved from the lower position to the normal position, the relative height of the imaging sensor 120 as viewed from the lens 110 is increased. The imaging sensor 120 is provided with a frame-shape stopped mechanism 125, and the imaging sensor 120 is configured to move in a movable area defined by the stopper mechanism 125. The stopper mechanism 125 may be to prevent excessive movement of the imaging sensor 120.

(2) Deviation from Field Angle in Stopping at a Red Light

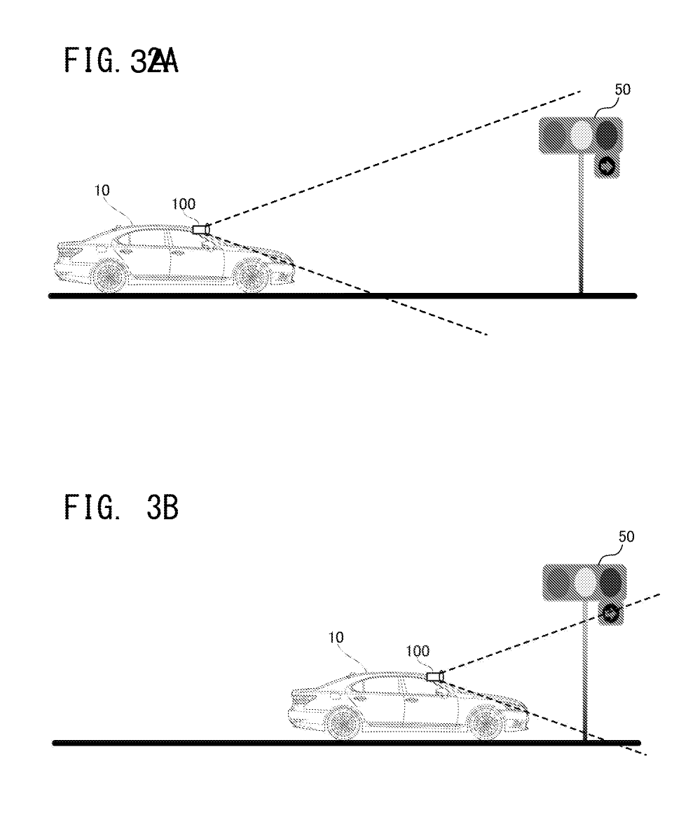

Next, deviation of the traffic light from a field angle or a viewing angle, which occurs when the vehicle stops at a red light, will be explained with reference to FIG. 3A and FIG. 3B. FIG. 3A and FIG. 3B are conceptual diagrams illustrating an example of the deviation of the traffic light from the field angle, which occurs in stopping at the red light.

As illustrated in FIG. 3A, if a distance between the vehicle 10 and a traffic light 50 is relatively long, the traffic light 50 is included in the imaging range of the imaging apparatus 100. On the other hand, if the distance between the vehicle 10 and the traffic light 50 is relatively short, the traffic light 50 is located in an upper direction as viewed from the vehicle 10, and the traffic light 50 may be thus out of the imaging range of the imaging apparatus 100; namely, there may be the deviation from the field view. If there is the deviation of the traffic light 50 from the field view, for example, the color of the traffic light 50 cannot be recognized by using the photographed image.

If the traffic light 50 is green and if the vehicle 10 passes the traffic light 50, there is no problem even when the vehicle 10 approaches the traffic light and temporarily cannot recognize the color of the traffic light 50. However, if the traffic light 50 is red and if the vehicle 10 stops near the traffic light 50, the color of the traffic light 50 cannot be subsequently recognized, which may cause a detrimental effect. For example, an automatic start control performed by recognizing the color of the traffic light 50 (which is specifically control of automatically starting the vehicle 10 when the traffic light changes from red to green) cannot be performed without recognizing the color of the traffic light 50.

The imaging apparatus 100 according to the first embodiment is configured to perform an imaging sensor control operation, which will be explained below, in order to avoid the detrimental effect that can occur when the vehicle 10 stops, as described above.

(3) Imaging Sensor Control Operation

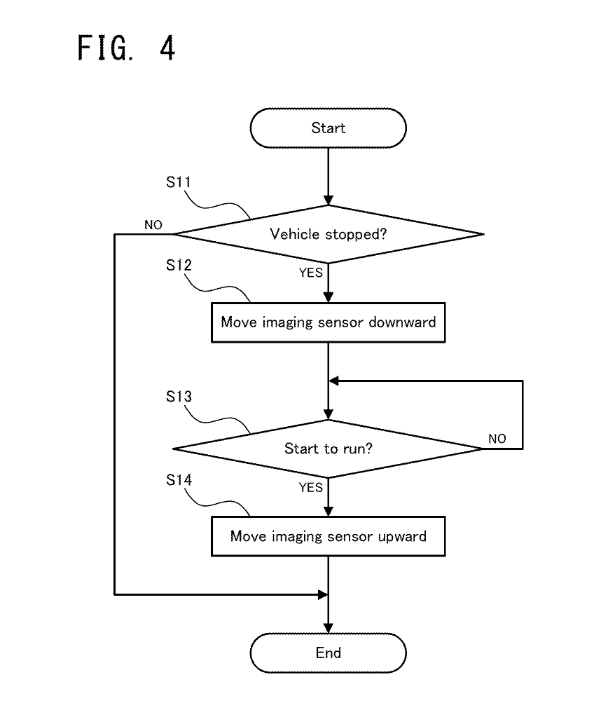

The imaging sensor control operation performed on the imaging apparatus according to the first embodiment will be specifically explained with reference to FIG. 4. FIG. 4 is a flowchart illustrating a flow of operation of the imaging apparatus according to the first embodiment.

As illustrated in FIG. 4, the imaging apparatus 100 according to the first embodiment determines whether or not the vehicle 10 is stopped, during the running of the vehicle 10 (step S11). Specifically, the vehicle speed determinator 160 may determine whether or not the vehicle speed is less than or equal to a first predetermined speed. The first predetermined speed is a specific example of the “predetermined speed” in Supplementary Notes described later, and may be set to zero or a value that is close to zero. The vehicle speed determinator 160 may determine that the vehicle 10 is stopped if the vehicle speed is less than or equal to the first predetermined speed, and may determine that the vehicle 10 is not stopped if the vehicle speed is greater than the first predetermined speed. If it is determined that the vehicle 10 is not stopped (the step S11: NO), the subsequent process is omitted, and a series of process operations is ended. In this case, the series of process operations of the imaging sensor control operation may be started from the beginning after a lapse of a predetermined period.

On the other hand, if it is determined that the vehicle 10 is stopped (the step S11: YES), the sensor controller 150 controls the operation of the actuator 140 and moves the position of the imaging sensor 120 downward (step S12). Specifically, the sensor controller 150 moves the position of the imaging sensor 120 from the normal position illustrated in FIG. 2A to the lower position illustrated in FIG. 2B.

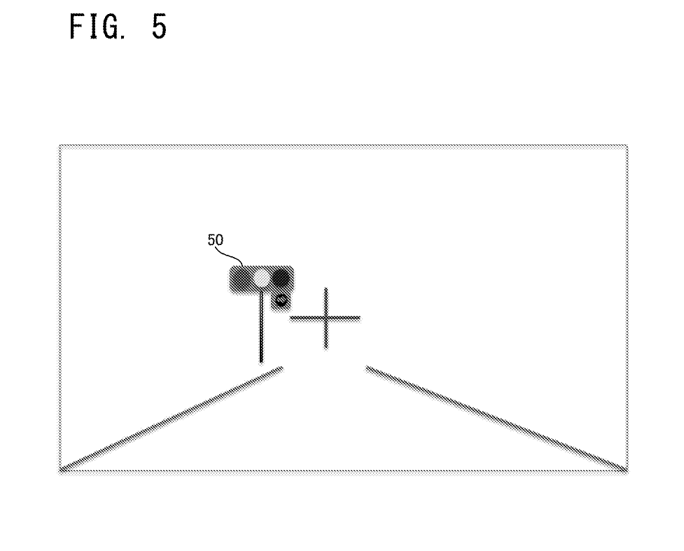

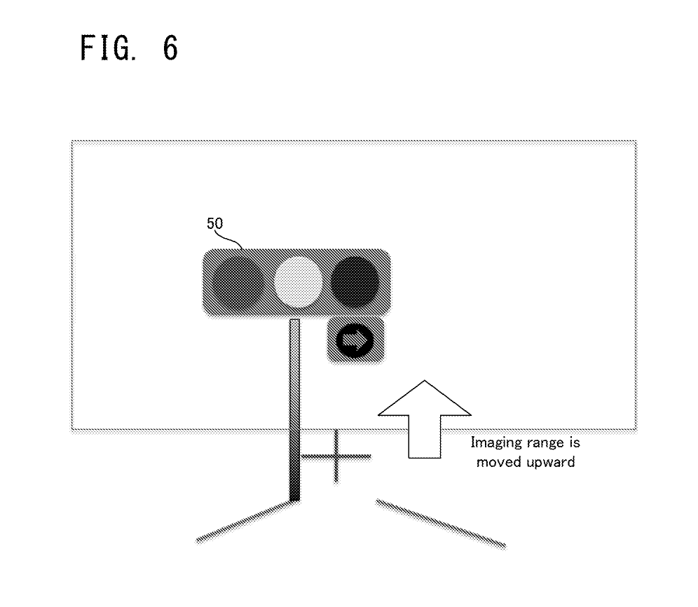

Here, a change in the imaging range due to the movement of the imaging sensor 120 will be specifically explained with reference to FIG. 5 and FIG. 6. FIG. 5 is a plan view illustrating the imaging range when the imaging sensor is at the normal position. FIG. 6 is a plan view illustrating the imaging range when the imaging sensor is at the lower position.

As illustrated in FIG. 5, if the imaging sensor 120 is at the normal position (i.e., at the position in FIG. 2A), a center of the photographed image substantially matches a focus of expansion (FOE).

On the other hand, as illustrated in FIG. 6, if the imaging sensor 120 is moved to the lower position (i.e., at the position in FIG. 2B), light that enters from above the lens 110 enters the imaging sensor 120. Thus, the center of the photographed image is moved to an upper side than the FOE. In other words, if the imaging sensor 120 is moved from the normal position to the lower position, the imaging range is moved upward. By moving the imaging range in this manner, it is possible to include the traffic light 50, which is located above the vehicle, in the imaging range even when the vehicle 10 stops near the traffic light 50. As a result, the color of the traffic light 50 can be image-recognized even when the vehicle is stopped at the red light. Therefore, it is possible to perform the automatic start control using a result of the recognition of the traffic light 50, or similar controls.

To what extent the position of the imaging sensor 120 is moved when the vehicle 10 stops may be determined depending on to what extent the imaging range is moved. To what extent the imaging range is moved may be determined by predicting a position of the traffic light 50 as viewed from the vehicle 10 that is stopped at the red light, for example, from a general height of the traffic light 50, a position of a stop line, or the like.

Back in FIG. 4, after the imaging sensor 120 is moved to the lower position, it is determined whether or not the vehicle 10 restarts to run (step S13). Specifically, the vehicle speed determinator 160 may determine whether or not the vehicle speed is greater than or equal to a second predetermined speed. The second predetermined speed may be set to be equal to the first predetermined speed, which is a threshold value for determining whether or not the vehicle 10 is stopped, or may be set to a value that is greater than the first predetermined speed. The vehicle speed determinator 160 may determine that the vehicle 10 remains stopped if the vehicle speed is less than the second predetermined speed, and may determine that the vehicle 10 starts to run if the vehicle speed is greater than or equal to the second predetermined speed. If it is determined that the vehicle 10 remains stopped (the step S13: NO), the imaging sensor 120 is kept at the lower position, and the determination process in the step S13 is repeated.

If it is determined that the vehicle 10 starts to run (the step S13: YES), the sensor controller 150 controls the operation of the actuator 140 and moves the position of the imaging sensor 120 upward. Specifically, the sensor controller 150 moves the position of the imaging sensor 120 from the lower position illustrated in FIG. 2B to the normal position illustrated in FIG. 2A. By this, it is possible to prevent that imaging range is kept on the upper side even though the vehicle 10 starts to run.

As explained above, according to the imaging apparatus 100 in the first embodiment, it is possible to certainly include the traffic light 50 in the imaging range, even when the vehicle 10 stops near the traffic light 50 and the traffic light 50 is located nearly right above as viewed from the vehicle because the imaging range is moved upward when the vehicle 10 stops. Moreover, particularly in the first embodiment, the imaging range is changed by moving the imaging sensor 120, which is relatively light. Thus, for example, in comparison with in moving the lens 110 and a camera main body 200 (refer to FIG. 2), it is possible to change the imaging range while suppressing an impact in the movement and current consumption required for the movement.

### Second Embodiment

Next, an imaging apparatus 100 according to a second embodiment will be explained. The second embodiment is partially different in configuration and operation from the aforementioned first embodiment, and the other part is substantially the same. Thus, hereinafter, a different part from that of the first embodiment explained above will be explained in detail, and an explanation of the same part will be omitted, as occasion demands.

(1) Configuration of Apparatus

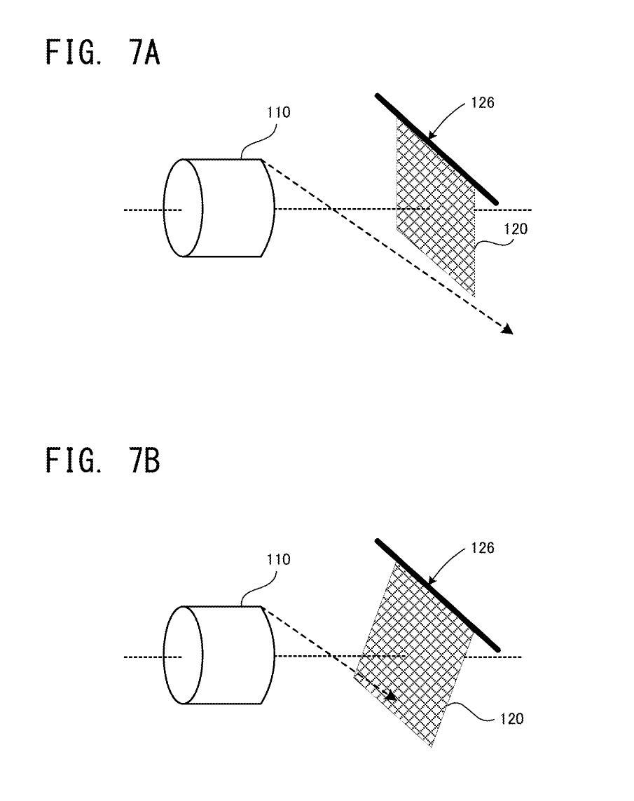

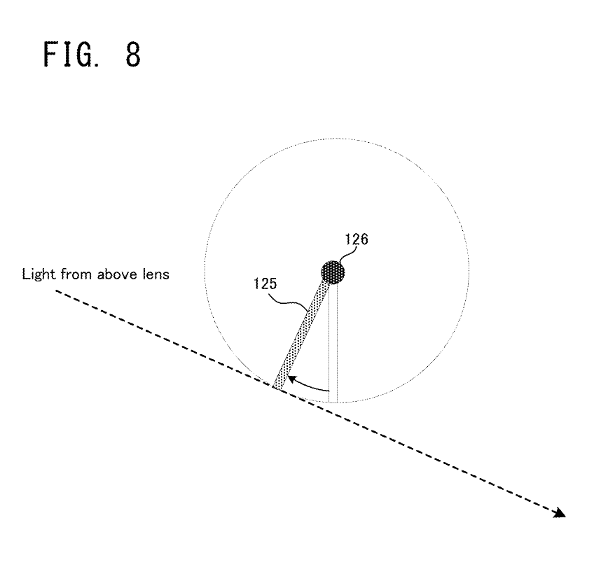

Firstly, a configuration of the imaging apparatus 100 according to the second embodiment will be explained with reference to FIG. 7A to FIG. 8. FIG. 7A and FIG. 7B are perspective views respectively illustrating states before and after moving the imaging sensor in the imaging apparatus according to the second embodiment. FIG. 8 is a side view illustrating a direction of driving the imaging sensor in the imaging apparatus according to the second embodiment. In FIG. 7A to FIG. 8, the same components as those of the imaging apparatus according to the first embodiment carry the same numerical references.

As illustrated in FIG. 7A and FIG. 7B, the imaging apparatus 100 according to the second embodiment is configured to rotate and drive the imaging sensor 200. Specifically, the imaging sensor 120 is configured to be rotated and driven on a rotating shaft 126, which is positioned to cross an optical axis of the lens 110. The rotating shaft 126 is mounted on an upper end of the imaging sensor 120. Thus, if the imaging sensor 120 is rotated, a lower end of the imaging sensor 120 is significantly moved. The imaging sensor 120 may be provided with the stopper mechanism 125 for preventing the excessive movement of the imaging sensor 120, illustration of which is omitted here.

The imaging sensor 120 according to the second embodiment is configured to move between at a normal position (refer to FIG. 7A) and at a rotation position (refer to FIG. 7B). The normal position here is the same as the normal position according to the first embodiment illustrated in FIG. 2A, while the rotation position is a position obtained by rotating the imaging sensor 120 by a predetermined angle to the lens 110 side from the normal position. At the rotation position, the lower end of the imaging sensor 120 is closer to the lens 110 in comparison with at the normal position. Thus, light that enters from above the lens 110 enters the imaging sensor 120.

In an example illustrated in FIG. 8, if the imaging sensor 120 is at the normal position, i.e., if the imaging sensor 120 is located right under the rotating shaft 126, the light that enters from above the lens 110 does not enter the imaging sensor 120. On the other hand, if the imaging sensor 120 is at the rotation position obtained by being rotated by the predetermined angle, the light that enters from above the lens 110 enters the imaging sensor 120. As a result, it is possible to photograph an image of a scene on the upper side, by moving the position of the imaging sensor 120 from the normal position to the rotation position. In other words, the imaging range is moved upward by moving the position of the imaging sensor 120 from the normal position to the rotation position. More specifically, the imaging range in the normal position is the same as that illustrated in FIG. 5, and the imaging range in the rotation position is the same as that illustrated in FIG. 6. The predetermined angle, which is a rotation angle of the imaging sensor 120, i.e., an angle difference between the normal position and the rotation position, may be determined depending on to what extent the imaging range is moved.

As explained above, according to the imaging apparatus 100 in the second embodiment, it is possible to change the imaging range as in the first embodiment, by rotating the imaging sensor 120. Thus, if the imaging sensor 120 is moved to the rotation position when the vehicle 10 stops, it is possible to certainly include the traffic light 50 in the imaging range even when the vehicle 10 stops near the traffic light 50 and the traffic light 50 is located nearly right above as viewed from the vehicle.

<Supplementary Notes>

Various aspects of embodiments of the present disclosure derived from the embodiments explained above will be explained hereinafter.

(Supplementary Note 1)

An imaging apparatus described in Supplementary Note 1 is configured to photograph an image of a scene ahead of a vehicle, the imaging apparatus provided with: an actuator configured to adjust a relative position of an imaging sensor with respect to a lens; and a controller configured to control the actuator in such a manner that light that enters from above the lens enters the imaging sensor when a speed of the vehicle is less than a predetermined speed, in comparison with when the speed of the vehicle is greater than the predetermined speed.

According to the imaging apparatus described in Supplementary Note 1, the actuator is controlled in such a manner that the light that enters from above the lens enters the imaging sensor when the speed of the vehicle is less than the predetermined speed, in comparison with when the speed of the vehicle is greater than the predetermined speed. If the light that enters from above the lens enters the imaging sensor, an imaging range of the apparatus is moved upward, and an object located at a higher position can be photographed. The “predetermined speed” may be a threshold value for determining whether or not the vehicle is substantially stopped, and may be set to zero or a value that is extremely close to zero.

When the vehicle stops at a red light, a traffic light is located at a higher position as viewed from the vehicle. Thus, if no measures are taken, the traffic light is possibly out of the imaging range of the imaging apparatus. If the traffic light cannot be photographed or imaged when the vehicle stops, a change in the color of the traffic light cannot be image-recognized. Thus, in a vehicle that performs the automatic start control together with a result of the recognition of the traffic light, the vehicle cannot start in appropriate timing.

In the imaging apparatus described in Supplementary Note 1, however, the position of the imaging sensor of the vehicle is controlled, by which the imaging range is moved upward. It is thus possible to certainly photograph the traffic light located at the higher position, even from the vehicle that is stopped at the red light. Moreover, the actuator controls only the imaging sensor that is relatively light. It is thus possible to change the imaging range, more easily and appropriately, than when driving a lens and an apparatus main body.

(Supplementary Note 2)

In one aspect of the imaging apparatus described in Supplementary Note 2, the actuator is configured to adjust a relative height of the imaging sensor with respect to the lens by moving the imaging sensor in a vertical direction, and the controller is configured to control the actuator in such a manner that the relative height is reduced when the speed of the vehicle is less than the predetermined speed, in comparison with when the speed of the vehicle is greater than the predetermined speed.

According to the imaging apparatus described in Supplementary Note 2, the relative height of the imaging sensor with respect to the lens is controlled to be reduced, by which the light that enters from above the lens enters the imaging sensor. In this aspect, it is sufficient to drive the imaging sensor in the vertical direction. It is thus possible to change the imaging range by a relatively simple drive mechanism.

(Supplementary Note 3)

In another aspect of the imaging apparatus described in Supplementary Note 3, the actuator is configured to adjust a relative position of a lower end of the imaging sensor with respect to the lens by rotating the imaging sensor on a shaft that crosses an optical axis of the lens, and the controller is configured to control the actuator in such a manner that the lower end of the imaging sensor approaches the lens when the speed of the vehicle is less than the predetermined speed, in comparison with when the speed of the vehicle is greater than the predetermined speed.

According to the imaging apparatus described in Supplementary Note 3, the lower end of the imaging sensor is controlled to approach the lens, by which the light that enters from above the lens enters the imaging sensor. In this aspect, it is sufficient to rotate and drive the imaging sensor. It is thus possible to change the imaging range by a relatively simple drive mechanism.

(Supplementary Note 4)

In one aspect of the imaging apparatus described in Supplementary Note 4, it is further provided with a stopper mechanism configured to limit a movable area of the imaging sensor.

According to the imaging apparatus described in Supplementary Note 4, it is possible to prevent that an excessive change in the position of the imaging sensor causes the imaging range to be inappropriate.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. An imaging apparatus configured to photograph an image of a scene ahead of a vehicle, said imaging apparatus comprising:
an actuator configured to adjust a relative position of an imaging sensor with respect to a lens; and
a controller configured to control said actuator in such a manner that light that enters from above the lens enters the imaging sensor when a speed of the vehicle is less than a predetermined speed, in comparison with when the speed of the vehicle is greater than the predetermined speed.

2. The imaging apparatus according to claim 1, wherein
said actuator is configured to adjust a relative height of the imaging sensor with respect to the lens by moving the imaging sensor in a vertical direction, and
said controller is configured to control said actuator in such a manner that the relative height is reduced when the speed of the vehicle is less than the predetermined speed, in comparison with when the speed of the vehicle is greater than the predetermined speed.

3. The imaging apparatus according to claim 1, wherein
said actuator is configured to adjust a relative position of a lower end of the imaging sensor with respect to the lens by rotating the imaging sensor on a shaft that crosses an optical axis of the lens, and
said controller is configured to control said actuator in such a manner that the lower end of the imaging sensor approaches the lens when the speed of the vehicle is less than the predetermined speed, in comparison with when the speed of the vehicle is greater than the predetermined speed.

4. The imaging apparatus according to claim 1, further comprising a stopper mechanism configured to limit a movable area of the imaging sensor.
